(19) United States
(12) Patent Application Publication
(10) Pub. No.: US 2021/0364143 A1
(43) Pub. Date: Nov. 25, 2021

(54) Vehicle Luminaire and Vehicle Lighting Tool

(71) Applicant: Toshiba Lighting & Technology Corporation, Yokosuka-shi (JP)

(72) Inventor: Kiyokazu Hino, Ehime-ken (JP)

(73) Assignee: Toshiba Lighting & Technology Corporation, Yokosuka-shi (JP)

(21) Appl. No.: 17/167,780

(22) Filed: Feb. 4, 2021

(30) Foreign Application Priority Data
May 20, 2020 (JP) 2020-087872

(51) Int. Cl. F21S 41/19; F21S 45/48; F21S 41/143; F21S 45/50; F21S 41/32; F21S 43/14; F21S 43/31; F21S 43/37

(52) U.S. Cl. CPC F21S 41/192; F21S 45/48; F21S 41/143; F21S 45/50; F21W 2103/55; F21S 43/14; F21S 43/31; F21S 43/37; F21S 41/321

(57) ABSTRACT

A vehicle luminaire according to an exemplary embodiment includes: a socket includes a flange, a mounting part, and contains a highly heat conductive resin; a light-emitting module includes at least one light-emitting element; and a heat transfer part is provided between the mounting part and the light-emitting module. An expression of 2.5 [watt]≤WT≤5.5 [watt], an expression of 15 [watt/(m·K)]≤WT≤25 [watt/(m·K)], and an expression of 40 [1/K]≤(A1−A2)×WT/W≤90 [1/K] are satisfied. W [watt] represents electric power that is applied to the light-emitting module. WT [watt/(m·K)] represents heat conductivity of the highly heat conductive resin. A1 [mm] represents a dimension of the flange in a direction orthogonal to a central axis of the vehicle luminaire. A2 [mm] represents a dimension of the mounting part in a direction orthogonal to the central axis of the vehicle luminaire.

### CROSS-REFERENCE TO RELATED APPLICATIONS

This application is based upon and claims the benefit of priority from Japanese Patent Application No. 2020-087872, filed on May 20, 2020; the entire contents of which are incorporated herein by reference.

### FIELD

Exemplary embodiments described here generally relate to a vehicle luminaire and a vehicle lighting tool.

### BACKGROUND

There is disclosed a vehicle luminaire including a socket and a light-emitting module including a light-emitting diode. The socket includes a flange, a mounting part that is provided on one side of the flange, and a thermal radiation fin that is provided on a side of the flange which is opposite to the mounting part side. A light-emitting module is provided in an end on a side of the mounting part which is opposite to the flange side. In the vehicle luminaire, heat generated in the light-emitting diode is transferred to the flange mainly through the mounting part. A part of heat transferred to the flange is discharged to the outside through a housing of a vehicle lighting tool to which the vehicle luminaire is mounted, or the like. In addition, a part of heat transferred to the flange is transferred to the thermal radiation fin, and is discharged to the outside from the thermal radiation fin.

Here, in recent, in order to realize a reduction in size and weight of the vehicle luminaire, there is a tendency that a dimension (outer diameter dimension) of the mounting part and a dimension (outer diameter dimension) of the flange in a direction orthogonal to a central axis of the vehicle luminaire decrease. In addition, in order to realize a reduction in weight of the vehicle luminaire, a socket formed from a highly heat conductive resin was used instead of a metal such as aluminum.

Since the outer diameter dimension of the mounting part and the outer diameter dimension of the flange take part in heat conduction, when simply reducing the dimensions, there is a concern that thermal radiation properties deteriorate. In addition, since heat conductivity of the highly heat conductive resin is lower than heat conductivity of a metal, when using the socket containing the highly heat conductive resin, an influence of the outer diameter dimension of the mounting part and the outer diameter dimension of the flange on the thermal radiation properties also increases.

Here, it is desired to develop a technology capable of realizing an improvement of thermal radiation properties and a reduction in size and weight.

### DESCRIPTION OF THE DRAWINGS

FIG. 1 is a schematic perspective view illustrating a vehicle luminaire according to an exemplary embodiment.

FIG. 2 is a cross-sectional view taken along line A-A.

FIG. 3 is a table showing an influence of a difference between an outer diameter dimension of a flange and an outer diameter dimension of a mounting part on thermal radiation properties and a reduction in size and weight of a socket.

FIG. 4 is a table showing an influence of a length of a thermal radiation fin on the thermal radiation properties and the reduction in size and weight of the socket.

FIG. 5 is a schematic partial cross-sectional view illustrating a vehicle lighting tool.

### DETAILED DESCRIPTION

A vehicle luminaire according an exemplary embodiment includes: a socket that includes a flange, a mounting part that is provided on one side of the flange, and a thermal radiation fin that is provided on a side of the flange which is opposite to the mounting part side, and contains a highly heat conductive resin; a light-emitting module that is provided in an end of the mounting part on a side opposite to the flange side, and includes at least one light-emitting element; and a heat transfer part that is provided between the mounting part and the light-emitting module, and contains a metal.

An expression of 2.5 [watt]≤W≤5.5 [watt], an expression of 15 [watt/(m·K)]≤WT≤[watt/(m·K)], and an expression of 40 [1/K]≤(A1−A2)×WT/W≤90 [1/K] are satisfied.

W [watt] represents electric power that is applied to the light-emitting module.

WT [watt/(m·K)] represents heat conductivity of the highly heat conductive resin.

A1 [mm] represents a dimension of the flange in a direction orthogonal to a central axis of the vehicle luminaire.

A2 [mm] represents a dimension of the mounting part in a direction orthogonal to the central axis of the vehicle luminaire.

Hereinafter, the exemplary embodiment will be described with reference the accompanying drawings. Note that, in the drawings, the same reference numeral will be given to the same constituent element, and detailed description thereof will be appropriately omitted.

(Vehicle Luminaire)

A vehicle luminaire 1 according to this embodiment can be provided, for example, in an automobile, a railway vehicle, and the like. Examples of the vehicle luminaire 1 provided in the automobile include vehicle luminaires which can be used in a front combination light (for example, an appropriate combination of a daytime running lamp (DRL), a position lamp, a turn signal lamp, and the like), a rear combination light (for example, an appropriate combination of a stop lamp, a tail lamp, a turn signal lamp, a back lamp, a fog lamp, and the like), and the like. However, the use of the vehicle luminaire 1 is not limited to the examples.

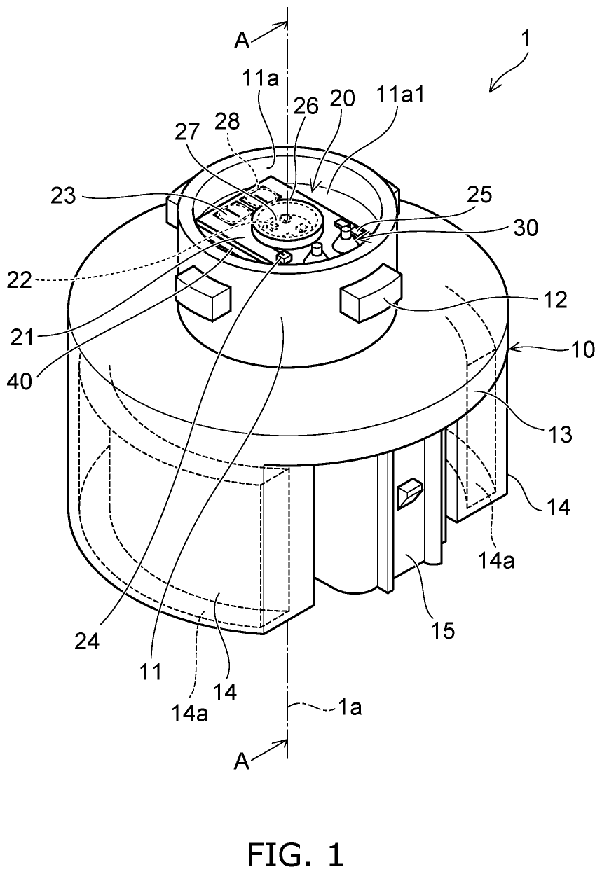

FIG. 1 is a schematic perspective view illustrating the vehicle luminaire 1 according to this embodiment.

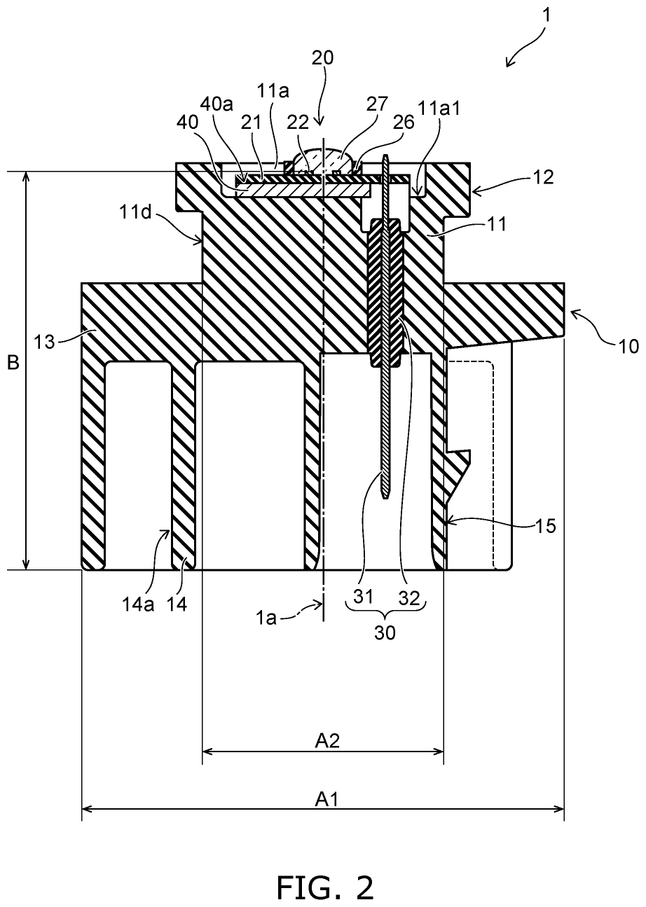

FIG. 2 is a cross-sectional view taken along line A-A in the vehicle luminaire 1 in FIG. 1.

As illustrated in FIG. 1 and FIG. 2, a socket 10, a light-emitting module 20, a power-supply part 30, and a heat transfer part 40 can be provided in the vehicle luminaire 1.

A mounting part 11, a bayonet 12, a flange 13, a thermal radiation fin 14, and a connector holder 15 can be provided in the socket 10.

The mounting part 11 is provided on one side of the flange 13. An external shape of the mounting part 11 can be set to a columnar shape. For example, the external shape of the mounting part 11 can be set to a circular column shape. The mounting part 11 includes a concave part 11a that is opened to an end surface on a side opposite to the flange 13 side.

A plurality of the bayonets 12 can be provided on a lateral surface 11d of the mounting part 11. The plurality of bayonets 12 protrude toward an outer side of the vehicle luminaire 1. The plurality of bayonets 12 face the flange 13. The plurality of bayonets 12 can be used when mounting the vehicle luminaire 1 to a housing 101 of a vehicle lighting tool 100. The plurality of bayonets 12 can be used for twist-lock.

The flange 13 has a plate shape. For example, the flange 13 can be set to have a disk shape. An outer surface of the flange 13 can be located on an outer side of the vehicle luminaire 1 in comparison to an outer surface of each of the bayonets 12.

The thermal radiation fin 14 can be provided on a side of the flange 13 which is opposite to the mounting part 11 side. As the thermal radiation fin 14, at least one piece can be provided. The number of the thermal radiation fins 14 can be appropriately changed in correspondence with the size of the flange 13 or the like. When providing a plurality of the thermal radiation fins 14, the plurality of thermal radiation fins 14 can be provided in parallel in a predetermined direction.

As illustrated in FIG. 1 and FIG. 2, the thermal radiation fin 14 can be set to have a tubular shape. That is, the thermal radiation fin 14 can includes a concave part 14a that has a columnar shape and is opened to an end surface on a side opposite to the flange 13 side.

Here, when mounting the vehicle luminaire 1 to the housing 101 of the vehicle lighting tool 100 through twist-lock, a worker may grip a lateral surface of the thermal radiation fin 14. In the case of the thermal radiation fin 14 having the tubular shape, bending rigidity can be further enlarged in comparison to a thermal radiation fin having a plate shape, and thus even when the worker grips the lateral surface of the thermal radiation fin 14, it is possible to prevent the thermal radiation fin 14 from being broken.

On the other hand, in the case of the thermal radiation fin having a plate shape, since the number of the thermal radiation fins can be increased, a thermal radiation area can be enlarged. When the thermal radiation area can be enlarged, it is possible to realize an improvement of thermal radiation properties.

In recent, a reduction in size and weight of the vehicle luminaire 1 is desired. Accordingly, in a direction orthogonal to a central axis 1a of the vehicle luminaire 1, there is a tendency that a dimension (outer diameter dimension A2) of the mounting part 11 and a dimension (outer diameter dimension A1) of the flange 13 decease. When the outer diameter dimension A1 of the flange 13 decreases, a distance between the central axis 1a and a lateral surface of the thermal radiation fin 14 is shortened, and thus when mounting the vehicle luminaire 1, a force (rotational force) necessary to be applied to the thermal radiation fin 14 increases. When the force necessary to be applied to the thermal radiation fin 14 increases, breakage of the thermal radiation fin 14 is likely to occur.

In addition, as to be described later, it is preferable that the socket 10 is formed by using a highly heat conductive resin in consideration of a reduction in weight of the vehicle luminaire 1. However, since the highly heat conductive resin is more brittle than a metal such as aluminum, when forming the socket 10 (thermal radiation fin 14) by using the highly heat conductive resin, breakage of the thermal radiation fin 14 is likely to occur. Note that, for example, the highly heat conductive resin can be set to contain a resin and a filler using an inorganic material. For example, the highly heat conductive resin can be obtained by mixing a filler using carbon, aluminum oxide, or the like in a resin such as polyethylene terephthalate (PET) and nylon.

In the case of the thermal radiation fin 14 having a tubular shape, the bending rigidity can be enlarged, even in the socket 10 in which the outer diameter dimension A1 of the flange 13 is reduced so as to realize a reduction in size and weight, or which contains the highly heat conductive resin, the breakage of thermal radiation fin 14 can be suppressed.

The connector holder 15 can be provided on a side of the flange 13 which is opposite to the mounting part 11 side. The connector holder 15 has a tubular shape. A connector 105 including a sealing member 105a is inserted to the inside of the connector holder 15. Accordingly, a cross-sectional shape and a cross-sectional dimension of a hole of the connector holder 15 is set to be appropriate for a cross-sectional shape and a cross-sectional dimension of the connector 105 including the sealing member 105a.

Heat generated in the light-emitting module 20 is discharged to the outside mainly through the socket 10. Accordingly, it is preferable that the socket 10 is formed from a material having high heat conductivity. The material having high heat conductivity may be set as a metal such as aluminum, but it is preferable that the material is set as the highly heat conductive resin in consideration of a reduction in weight of the socket 10.

The mounting part 11, the bayonet 12, the flange 13, the thermal radiation fin 14, and the connector holder 15 can be integrally formed by using, for example, an injection molding method. In addition, the socket 10 and the power-supply part 30 can be integrally formed or the socket 10, the power-supply part 30, and the heat transfer part 40 can be integrally formed by using an insert molding method or the like.

The light-emitting module 20 (board 21) can be provided in an end of the mounting part 11 on a side opposite to the flange 13 side.

The board 21, a light-emitting element 22, a resistor 23, a control element 24, a capacitor 25, a frame part 26, a sealing part 27, and a covering part 28 can be provided in the light-emitting module 20.

The board 21 has a plate shape. For example, a planar shape of the board 21 can be set to have a rectangular shape. For example, the board 21 can be bonded to a surface 40a of the heat transfer part 40 on a side opposite to a bottom surface 11a1 side of the concave part 11a. In this case, as adhesive, adhesive with high heat conductivity is preferable. For example, the adhesive can be set as adhesive in which a filler using an inorganic material is mixed. For example, the board 21 can be formed from an inorganic material such as ceramics (for example, aluminum oxide, aluminum nitride, and the like), an organic material such as paper phenol and glass epoxy, or the like. In addition, the board 21 may be a metal core board obtained by coating a surface of a metal plate with an insulating material. When the amount of heat generation in the light-emitting element 22 is large, from the viewpoint of thermal radiation, it is preferable that the board 21 is formed by using a material with high heat conductivity. Examples of the material with high heat conductivity include ceramics such as aluminum oxide and aluminum nitride, a highly heat conductive resin, a metal core board, and the like. In addition, the board 21 may have a single-layer structure, or a multi-layer structure.

In addition, a wiring pattern can be provided on a surface of the board 21. For example, the wiring pattern can be formed from a material containing silver as a main component, a material containing copper as a main component, or the like.

As the light-emitting element 22, at least one piece can be provided. In the case of the light-emitting module 20 illustrated in FIG. 1 and FIG. 2, four light-emitting elements 22 are provided. Note that, the number of the light-emitting elements 22 can be appropriately changed in correspondence with the use or the size of the vehicle luminaire 1, or the like. When providing a plurality of the light-emitting elements 22, the plurality of light-emitting elements 22 can be connected in series. In addition, the light-emitting elements 22 can be connected to the resistor 23 in series.

Each of the light-emitting element 22 can be provided on a side of the board 21 which is opposite to the heat transfer part 40 side. The light-emitting element 22 can be electrically connected to the wiring pattern.

For example, the light-emitting element 22 can be set as a light-emitting diode, an organic light-emitting diode, a laser diode, or the like.

For example, the light-emitting element 22 can be set as a surface mounting type light-emitting element, a shell type light-emitting element including a lead wire, a chip-shaped light-emitting element, or the like. The light-emitting element illustrated in FIG. 1 and FIG. 2 is the chip-shaped light-emitting element. In this case, as the light-emitting element 22, the chip-shaped light-emitting element is preferable when considering a reduction in size of the light-emitting module 20. The chip-shaped light-emitting element 22 can be mounted by chip on board (COB). In this case, a lot of light-emitting elements 22 can be provided in a narrow region. Accordingly, a reduction in size of the light-emitting module 20, and a reduction in size of the vehicle luminaire 1 can be realized.

When the light-emitting element 22 is the chip-shaped light-emitting element, any one of a vertical electrode type light-emitting element, an upper electrode type light emitting element, and a flip chip type light-emitting element may be employed. The vertical electrode type light-emitting element and the upper electrode type light-emitting element can be electrically connected to the wiring pattern by a wire. The flip chip type light-emitting element can be directly mounted to the wiring pattern.

The number, the size, the arrangement, and the like of a plurality of the light-emitting elements 22 are not limited to the example, and can be appropriately changed in correspondence with the size, the use, and the like of the vehicle luminaire 1.

The resistor 23 can be provided on a side of the board 21 which is opposite to the heat transfer part 40 side. As the resistor 23, at least one piece can be provided. The resistor 23 can be electrically connected to the wiring pattern.

For example, the resistor 23 can be set as a surface mounting type resistor, a resistor (metal oxide film resistor) including a lead wire, a film-shaped resistor formed by using a screen printing method or the like, or the like. The resistor 23 illustrated in FIG. 1 is the film-shaped resistor.

For example, a material of the film-shaped resistor can be set as ruthenium oxide (RuO2). For example, the film-shaped resistor can be formed by using a screen printing method and a baking method. When the resistor 23 is the film-shaped resistor, a contact area between the resistor 23 and the board 21 can be enlarged, and thus thermal radiation properties can be improved. In addition, a plurality of the resistors 23 can be formed at a time. Accordingly, productivity can be improved. In addition, a variation in a resistance value in the plurality of resistors 23 can be suppressed.

Here, since a variation exists in forward voltage characteristics of each of the light-emitting elements 22, when an application voltage between an anode terminal and a ground terminal is set to be constant, a variation occurs in the brightness (luminous flux, luminance, luminous intensity, and illuminance) of light emitted from the light-emitting element 22. Accordingly, a value of a current flowing to the light-emitting element 22 is set to be within a predetermined range by the resistor 23 so that the brightness of light emitted from the light-emitting element 22 enters a predetermined range. In this case, the value of the current flowing to the light-emitting element 22 is set to be within the predetermined range by changing a resistance value of the resistor 23.

When the resistor 23 is a film-shaped resistor, when a part of the resistor 23 is removed, the resistance value can be increased. For example, the part of the resistor 23 can be easily removed by irradiating the resistor 23 with laser light. When the resistor 23 is a surface mounting type resistor, a resistor including a lead wire, or the like, the resistor 23 having an appropriate resistance value can be selected in correspondence with the forward voltage characteristics of the light-emitting element 22. The number, size, arrangement, and the like of the resistor 23 are not limited to the exemplary configuration, and can be appropriately changed in correspondence with the number, specifications, and the like of the light-emitting elements 22.

The control element 24 can be provided on a side of the board 21 which is opposite to the heat transfer part 40 side.

As the control element 24, at least one piece can be provided. The control element 24 can be electrically connected to the wiring pattern. The control element 24 can be connected to the plurality of light-emitting elements 22 and the resistor 23 in series.

For example, the control element 24 can be provided so that a reverse voltage and a pulse noise from the reverse direction are not applied to the light-emitting elements 22. For example, the control element 24 can be set as a diode. For example, the control element 24 can be set as a surface mounting type diode, a diode including a lead wire, a chip-shaped diode, or the like. The control element 24 illustrated in FIG. 1 is the surface mounting type diode.

For example, the capacitor 25 can be provided to make a countermeasure for noise or to smooth a voltage. The capacitor 25 can be provided on a side of the board 21 which is opposite to the heat transfer part 40 side. As the capacitor 25, at least one piece can be provided. The capacitor 25 can be electrically connected to the wiring pattern. The capacitor 25 can be connected to the light-emitting element 22 in parallel. The capacitor 25 can be set as a chip-shaped capacitor or a surface mounting type capacitor.

The frame part 26 can be provided on a side of the board 21 which is opposite to the heat transfer part 40 side. The frame part 26 can be bonded to the board 21. In this case, the frame part 26 can be bonded to the board 21 by adhesive, or can be bonded by a part of the sealing part 27 provided between the frame part 26 and the board 21.

The frame part 26 can be set to have a frame shape. The light-emitting element 22 can be provided in a region surrounded by the frame part 26. For example, the frame part 26 can surround a plurality of the light-emitting elements 22. The frame part 26 can be formed from a resin. For example, the resin can be a thermoplastic resin such as polybutylene terephthalate (PBT), polycarbonate (PC), PET, nylon, polypropylene (PP), polyethylene (PE), and polystyrene (PS). For example, the frame part 26 can be formed by an injection molding method or the like.

In addition, the frame part 26 can be formed from a resin containing particles of titanium oxide or the like, or can be formed from a white resin. In this case, reflectance with respect to light emitted from the light-emitting element 22 can be improved. In addition, an inner wall surface of the frame part 26 can be set as an inclined surface that is inclined in a direction to be spaced apart from a central axis of the frame part 26 as being spaced apart from the board 21.

That is, the frame part 26 can also have a function of a reflector.

Note that, description was given of a case where the frame part 26 is formed in advance, and the formed frame part 26 is bonded to the board 21. However, the frame part 26 can be formed by supplying a softened resin onto the board 21 in a frame shape, and by curing the resin. For example, a resin that is softened by adding a solvent or the like to the resin or a resin that is softened by heating the resin is supplied onto the board 21 in an annular shape, and the resin is cured to form the frame part 26. For example, supply of the softened resin can be carried out by using a dispenser, a hot melt device, or the like.

Note that, the frame part 26 can also be omitted. When the frame part 26 is omitted, a dome-shaped sealing part 27 that covers the light-emitting element 22 can be provided. Note that, when the frame part 26 is provided, a formation range of the sealing part 27 can be defined. Accordingly, an increase in a planar dimension of the sealing part 27 can be suppressed, and thus a reduction in size of the light-emitting module 20 and a reduction in size of the vehicle luminaire 1 can be realized.

The sealing part 27 can be provided on an inner side of the frame part 26. The sealing part 27 can be provided to cover a region surrounded by the frame part 26. The sealing part 27 covers the light-emitting element 22. The sealing part 27 has a function of protecting the chip-shaped light-emitting element 22. Note that, when the light-emitting element 22 is the surface mounting type light-emitting element, the shell type light-emitting element including a lead wire, or the like, the frame part 26 and the sealing part 27 can be omitted.

The sealing part 27 can be formed from a resin having translucency. For example, the sealing part 27 can be formed from a silicone resin or the like. For example, the sealing part 27 can be formed by filling a region surrounded by the frame part 26 with a resin that is softened by using a solvent or the like. Filling of the resin can be performed, for example, by using a dispenser or the like. In addition, a phosphor can be contained in the sealing part 27. In addition, for example, the phosphor can be set as an yttrium-aluminum-garnet-based phosphor (YAG-based phosphor). However, the type of the phosphor can be appropriately changed so as to obtain a predetermined emission color in correspondence with the use of the vehicle luminaire 1 or the like.

The covering part 28 can cover the wiring pattern and the film-shaped resistor 23. The covering part 28 can be provided to protect the wiring pattern and the film-shaped resistor 23. For example, the covering part 28 can contain a resin, a glass material, or the like.

The power-supply part 30 can include a plurality of power-supply terminals 31 and an insulating part 32.

The plurality of power-supply terminals 31 can be set as a rod-shaped body. The plurality of power-supply terminals 31 protrude from the bottom surface 11a1 of the concave part 11a. The plurality of power-supply terminals 31 can be provided in parallel in a predetermined direction. The plurality of power-supply terminals 31 are provided inside the insulating part 32. Ends of the plurality of power-supply terminals 31 on the light-emitting module 20 side are soldered to the wiring pattern. Ends of the plurality of power-supply terminals 31 on the thermal radiation fin 14 side are exposed to the inside of the connector holder 15. The connector 105 can be fitted to the plurality of power-supply terminals 31 exposed to the inside of the connector holder 15. The plurality of power-supply terminals 31 can have electrical conductivity. For example, the plurality of power-supply terminals 31 can be formed from a metal such as a copper alloy. Note that, the number, the shape, the arrangement, the material, and the like of the plurality of power-supply terminals 31 are not limited to the example, and can be appropriately changed.

The highly heat conductive resin that is the material of the socket 10 may have electrical conductivity. For example, a highly heat conductive resin containing a filler formed from carbon has electrical conductivity. Accordingly, the insulating part 32 is provided for insulation between the plurality of power-supply terminals 31 and the socket 10 having electrical conductivity. In addition, the insulating part 32 also has a function of holding the plurality of power-supply terminals 31. Note that, when the socket 10 is formed from the highly heat conductive resin (for example, a highly heat conductive resin containing a filler formed from ceramics, or the like) having insulation properties, the insulating part 32 can be omitted. In this case, the socket 10 holds the plurality of power-supply terminals 31.

The insulating part 32 can be formed from a resin having insulation properties. For example, the insulating part 32 can be formed from PET, nylon, or the like. For example, the insulating part 32 can be pressed into a hole provided in the socket 10, can be bonded to the inside of the hole, or can be welded to the inside of the hole.

The heat transfer part 40 can be provided between the mounting part 11 and the light-emitting module 20. The heat transfer part 40 is preferably formed from a material with high heat conductivity. For example, the heat transfer part 40 can be formed from a metal such as aluminum, an aluminum alloy, copper, and a copper alloy. The heat transfer part 40 can be bonded to the bottom surface 11a1 of the concave part 11a. In this case, adhesive can be set to be the same as the adhesive for bonding the board 21 to the surface 40a of the heat transfer part 40. In addition, the heat transfer part 40 can be attached to the bottom surface 11a1 of the concave part 11a through a layer including heat conductive grease (thermal radiation grease). As the heat conductive grease, for example, grease obtained by mixing a filler using an inorganic material in modified silicone can be used. In addition, the heat transfer part 40 can also be inserted into the bottom surface 11a1 of the concave part 11a by using an insert molding method or the like.

Note that, when heat generated in the light-emitting module 20 is less, the heat transfer part 40 can also be omitted. However, in recent, it is demanded to further increase the brightness of light emitted from the light-emitting element 22, and thus electric power applied to the light-emitting module 20 may be 2.5 watts or greater.

In this case, since heat generated in the light-emitting module 20 increases, it is preferable that the heat transfer part 40 is provided, and the socket 10 is formed by using a highly heat conductive resin having heat conductivity of 15 watts/(m·K) or greater. The heat conductivity of the highly heat conductive resin can be adjusted by the amount of filler contained. For example, the amount of filler contained increases, the heat conductivity can be raised.

However, when increasing the amount of filler contained, the highly heat conductive resin becomes brittle. In addition, as described above, when the outer diameter dimension A1 of the flange 13 decreases due to a reduction in size and weight of the vehicle luminaire 1, when mounting the vehicle luminaire 1, a force necessary to be applied to the thermal radiation fin 14 increases. Accordingly, when the amount of the filler contained excessively increases to raise the heat conductivity, breakage of the thermal radiation fin 14 is likely to occur.

According to findings obtained by the present inventors, the electric power applied to the light-emitting module 20 is 2.5 to 5.5 watts, it is preferable that the heat transfer part 40 is provided, and the socket 10 is set to contain a highly heat conductive resin having heat conductivity of 15 to 25 watts/(m·K). In this case, it is possible to suppress a temperature of the light-emitting element 22 from exceeding a maximum junction temperature, and it is possible to suppress occurrence of the breakage of the thermal radiation fin 14.

In addition, according to findings obtained by the present inventors, when setting the outer diameter dimension A2 of the mounting part 11 is set to 19 [mm] or less to realize a reduction in size and weight of the vehicle luminaire 1, a difference between the outer diameter dimension A1 of the flange 13 and the outer diameter dimension A2 of the mounting part 11 has an influence on thermal radiation properties of the socket 10.

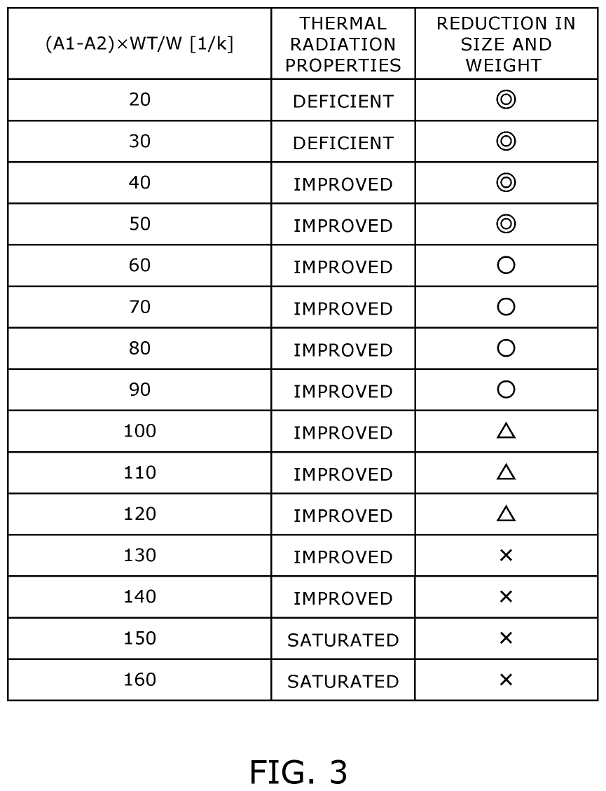

FIG. 3 is a table showing an influence of the difference between the outer diameter dimension A1 [mm] of the flange 13 and the outer diameter dimension A2 [mm] of the mounting part 11 on the thermal radiation properties and a reduction in size and weight of the socket 10.

Note that, FIG. 3 corresponds to a case where application electric power W is 2.5 to 5.5 watts, the heat conductivity WT of the highly heat conductive resin is 15 to 25 watts/(m·K), and the outer diameter dimension A2 of the mounting part 11 is 19 [mm] or less. In addition, it is assumed that the heat transfer part 40 is provided. Note that, “saturated” in FIG. 3 represents that the thermal radiation properties are not further improved.

As can be seen from FIG. 3, when a relationship of “40 [1/K]≤(A1−A2)×WT/W≤90 [1/K]” is satisfied, the thermal radiation properties of the socket 10 can be improved, and a reduction in size and weight of the socket 10 can be realized.

In addition, when increasing the length of the thermal radiation fin 14 in a direction along the central axis 1a of the vehicle luminaire 1, the thermal radiation area is enlarged, and thus the thermal radiation properties of the socket 10 can be improved. However, it was found that even though increasing the length of the thermal radiation fin 14, the thermal radiation properties may not be further improved.

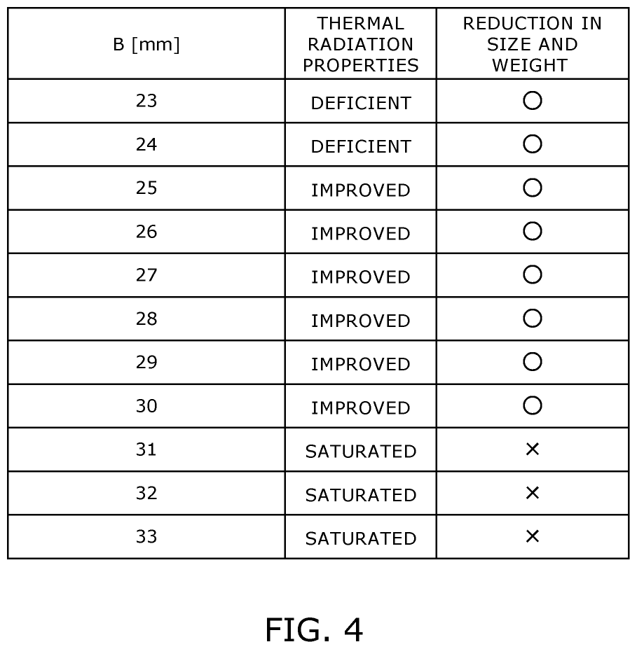

FIG. 4 is a table showing an influence of the length of the thermal radiation fin 14 on the thermal radiation properties and the reduction in size and weight of the socket 10.

Note that, a dimension B [mm] in FIG. 4 represents a dimension between a light-emitting surface (upper surface) of the light-emitting element 22 and an end surface of the thermal radiation fin 14 on a side opposite to the flange 13 side in a direction along the central axis 1a of the vehicle luminaire 1.

Note that, FIG. 4 corresponds to a case where application electric power W is 2.5 to 5.5 watts, the heat conductivity WT of the highly heat conductive resin is 15 to 25 watts/(m·K), and the outer diameter dimension A2 of the mounting part 11 is 19 [mm] or less. In addition, it is assumed that the heat transfer part 40 is provided. Note that, “saturated” in FIG. 4 represents that the thermal radiation properties are not further improved.

As can be seen from FIG. 4, the longer the dimension B is, the higher the thermal radiation properties become. However, when the dimension B becomes 31 [mm] or greater, the thermal radiation properties cannot be further improved, and an increase in size and weight of the socket 10 is caused by the increase of the dimension B.

Accordingly, as can be seen from FIG. 4, a relationship of “25 [mm]≤B≤30 [mm]” is preferable.

(Vehicle Lighting Tool)

Next, the vehicle lighting tool 100 will be described.

Note that, in the following description, as an example, description will be given of a case where the vehicle lighting tool 100 is the front combination light that is provided in automobiles. However, the vehicle lighting tool 100 is not limited to the front combination light that is provided in automobiles. The vehicle lighting tool 100 may be a vehicle lighting tool that is provided in automobiles, railway vehicles, or the like.

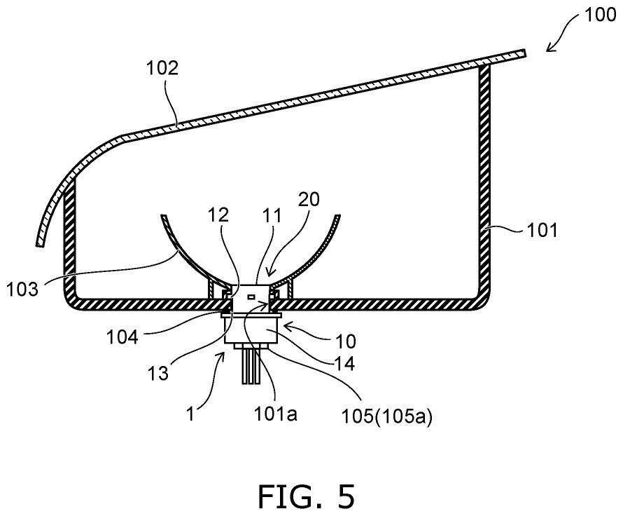

FIG. 5 is a schematic partial cross-sectional view for illustrating the vehicle lighting tool 100.

As illustrated in FIG. 5, the vehicle luminaire 1, the housing 101, a cover 102, an optical element 103, a sealing member 104, and the connector 105 can be provided in the vehicle lighting tool 100.

The housing 101 holds the mounting part 11. The housing 101 has a box shape in which one end side is opened. For example, the housing 101 can be formed from a resin or the like through which light is not transmitted. An attachment hole 101a, into which a portion of the mounting part 11 where the bayonet 12 is provided is inserted, can be provided in a bottom surface of the housing 101. A concave part, into which the bayonet 12 provided in the mounting part 11 is inserted, can be provided in a peripheral edge of the attachment hole 101a. Note that, description was given of a case where the attachment hole 101a is directly provided in the housing 101, but an attaching member including the attachment hole 101a may be provided in the housing 101.

When mounting the vehicle luminaire 1 to the vehicle lighting tool 100, the portion of the mounting part 11 where the bayonet 12 is provided is inserted into the attachment hole 101a, and the vehicle luminaire 1 is rotated. In this case, the bayonet 12 is held to a fitting part provided in the peripheral edge of the attachment hole 101a. This attachment method is referred to as twist-lock.

The cover 102 can be provided to cover an opening of the housing 101. The cover 102 can be formed from a resin or the like having translucency. The cover 102 can be set to have a function of a lens or the like.

Light emitted from the vehicle luminaire 1 is incident to the optical element 103. The optical element 103 can carry out reflection, diffusion, guiding, condensing, formation of a predetermined luminous intensity distribution pattern, and the like with respect to the light emitted from the vehicle luminaire 1. For example, the optical element 103 illustrated in FIG. 5 is a reflector. In this case, the optical element 103 reflects the light emitted from the vehicle luminaire 1 to form a predetermined luminous intensity distribution pattern.

The sealing member 104 can be provided between the flange 13 and the housing 101. The sealing member 104 can have an annular shape. The sealing member 104 can be formed from a material such as a rubber and a silicone resin which have elasticity.

When the vehicle luminaire 1 is mounted to the vehicle lighting tool 100, the sealing member 104 is sandwiched between the flange 13 and the housing 101. Accordingly, an internal space of the housing 101 can be hermetically sealed by the sealing member 104. In addition, the bayonet 12 is pressed against the housing 101 due to an elastic force of the sealing member 104. Accordingly, the vehicle luminaire 1 can be suppressed from being detached from the housing 101.

The connector 105 can be fitted to ends of the plurality of power-supply terminals 31 which are exposed to the inside of the connector holder 15. A power-supply (not illustrated) or the like can be electrically connected to the connector 105. Accordingly, when the connector 105 is fitted to the ends of the plurality of power-supply terminals 31, the power-supply (not illustrated) or the like and the light-emitting element 22 can be electrically connected.

A sealing member 105a is provided in the connector 105. The sealing member 105a is provided to prevent water from intruding to the inside of the connector holder 15. When the connector 105 including the sealing member 105a is inserted to the inside of the connector holder 15, the inside of the connector holder 15 is water-tightly sealed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A vehicle luminaire comprising:
a socket that includes a flange, a mounting part that is provided on one side of the flange, and a thermal radiation fin that is provided on a side of the flange which is opposite to the mounting part side, and contains a highly heat conductive resin;
a light-emitting module that is provided in an end of the mounting part on a side opposite to the flange side, and includes at least one light-emitting element; and
a heat transfer part that is provided between the mounting part and the light-emitting module, and contains a metal,
an expression of 2.5 [watt]≤W≤5.5 [watt],
an expression of 15 [watt/(m·K)]≤WT≤25 [watt/(m·K)], and
an expression of 40 [1/K]≤(A1−A2)×WT/W≤90 [1/K] being satisfied,
W [watt] representing electric power that is applied to the light-emitting module,
WT [watt/(m·K)] representing heat conductivity of the highly heat conductive resin,
A1 [mm] representing a dimension of the flange in a direction orthogonal to a central axis of the vehicle luminaire, and
A2 [mm] representing a dimension of the mounting part in a direction orthogonal to the central axis of the vehicle luminaire.

2. The luminaire according to claim 1,
wherein in a direction along the central axis of the vehicle luminaire, when a dimension between a light-emitting surface of the light-emitting element and an end surface of the thermal radiation fin on a side opposite to the flange side is set as B [mm],
an expression of 25 [mm]≤B≤30 [mm] is further satisfied.

3. The luminaire according to claim 1,
wherein an expression of A2≤19 [mm] is further satisfied.

4. The luminaire according to claim 1,
wherein the thermal radiation fin has a tubular shape.

5. The luminaire according to claim 1,
wherein the thermal radiation fin includes a concave part that has a columnar shape and is opened to an end surface on a side opposite to the flange side.

6. The luminaire according to claim 1,
wherein the heat transfer part contains at least any one of aluminum, an aluminum alloy, copper, and a copper alloy.

7. The luminaire according to claim 1,
wherein the heat transfer part is bonded to the mounting part by using adhesive in which a filler using an inorganic material is mixed.

8. The luminaire according to claim 1,
wherein the heat transfer part is attached to the mounting part through grease in which a filler using an inorganic material is mixed.

9. The luminaire according to claim 1,
wherein the heat transfer part is embedded in the mounting part.

10. The luminaire according to claim 1,
wherein the light-emitting module further includes a board on which the light-emitting element is provided, and
the board is bonded to the heat transfer part by using adhesive in which a filler using an inorganic material is mixed.

11. The luminaire according to claim 10,
wherein the board contains at least any one of ceramics and a highly heat conductive resin.

12. The luminaire according to claim 10,
wherein the board is a metal core board.

13. The luminaire according to claim 1,
wherein a plurality of the light-emitting elements are provided, and
the plurality of light-emitting elements are connected in series.

14. The luminaire according to claim 1,
wherein the light-emitting element is at least any one of a surface mounting type light-emitting element, a light-emitting element including a lead wire, and a chip-shaped light-emitting element.

15. The luminaire according to claim 10,
wherein the light-emitting module further includes a frame part that surrounds the light-emitting element provide on the board.

16. The luminaire according to claim 15,
wherein the light-emitting element is a chip-shaped light-emitting element.

17. The luminaire according to claim 16,
wherein the light-emitting module further includes a sealing part that is provided on an inner side of the frame part and covers the chip-shaped light-emitting element.

18. The luminaire according to claim 17,
wherein the sealing part contains a resin having translucency.

19. The luminaire according to claim 10,
wherein the light-emitting module further includes a dome-shaped sealing part that is provided on the board and covers the chip-shaped light-emitting element.

20. A vehicle lighting tool comprising:
the vehicle luminaire according to claim 1; and
a housing to which the vehicle luminaire is mounted.
